(19) United States
(12) Patent Application Publication
(10) Pub. No.: US 2012/0191675 A1
(43) Pub. Date: Jul. 26, 2012

(54) DEVICE AND METHOD FOR ELIMINATING FILE DUPLICATION IN A DISTRIBUTED STORAGE SYSTEM

(75) Inventors: Kyung-Soo Kim, Gwangju-si (KR); Jae-Beom Cheon, Suwon-si (KR); Joo-Hyun Kim, Seoul (KR); Bong-sik Sihn, Gwangju-si (KR); Bong-Joo Jin, Chungju-si (KR); Hyoung-Choul Kim, Anyang-si (KR); Young-Gyu Kim, Seongnam-si (KR); Sun Choi, Seongnam-si (KR); Gu-Yong Lee, Seoul (KR)

(73) Assignee: PSPACE INC., Seongnam-si, Gyeonggi-do (KR)

(21) Appl. No.: 13/500,046

(22) PCT Filed: Nov. 4, 2010
(86) PCT No.: PCT/KR2010/007764

§ 371 Date: Apr. 3, 2012

(30) Foreign Application Priority Data
Nov. 23, 2009 (KR) 10-2009-0113516

(51) Int. Cl. G06F 7/00

(52) U.S. Cl. 707/692; 707/E17.002

(57) ABSTRACT

The present invention relates to an apparatus and method for eliminating duplication of a file in a distributed storage system. The apparatus and method for eliminating duplication of a file in a distributed storage system according to the present invention calculates a hash value of each chunk for an active file; calculates a secondary hash value by adding the hash values calculated for respective chunks; examines duplication of the file using the hash value of each chunk and the secondary hash value; and eliminates a duplicated file depending on a result of the examination.

### TECHNICAL FIELD

The present invention relates to an apparatus and method for eliminating duplication of a file in a distributed storage system (DSS), and more specifically, to an apparatus and method for examining duplication of an active file and eliminating duplication of the file using a hash algorithm, bit level comparison and the like in the process of operating a distributed storage system.

### BACKGROUND ART

A distributed storage system or a parallel storage system is a storage system which virtualizes a plurality of storage devices as one storage device. Such a distributed storage system does not store one file in one storage device, but the file is duplicated, stored and used in a plurality of virtualized storage devices in a distributed manner.

As an existing Redundant Array of Inexpensive Devices (RAID) storage device integrates a plurality of hard disks into one storage device to construct a further larger, further faster and further stable storage device, the distributed storage system may provide functions of a further larger, further faster and further stable storage system by configuring a plurality of storage devices into one storage device.

Such a distributed storage system technique is used as a core technique in cloud computing or the like, and if the number of storage devices configuring the distributed storage system increases further more, capacity and performance of the distributed storage system are proportionally enhanced, and cost-effectiveness of the Total Cost of Owner-ship is maximized. Therefore, the distributed storage system may provide high-level performance and expandability which cannot be provided by existing storage systems.

In relation to this, FIG. 1 is a view showing the configuration of a distributed storage system according to a conventional technique.

Referring to FIG. 1, a distributed storage system generally includes a plurality of storage servers (this corresponds to one virtual storage server) 110 for duplicating and storing a file in a distributed manner, and a metadata server 120 for creating and managing metadata of the file. If at least a client 130 requests input or output of a certain file through a network or the like, the metadata server 120 provides information on the storage servers 110 in which a corresponding file will be or is stored in a distributed manner. Then, the client 130 connects to the storage servers 110 and inputs or outputs the corresponding file, and thus the service is provided. (For reference, in the present invention, the terminology ‘file’ means contents inquired or requested by the client, including a file, data, contents, a chunk or the like).

Meanwhile, in such a distributed storage system, a plurality of storage servers is divided into operation servers and backup servers in order to efficiently manage files, and currently operating active files (data or contents) are stored in the operation servers having a good performance, whereas backup files which do not operate currently are stored in the backup servers having a somewhat low performance, and thus limited storage media can be used efficiently.

However, since a file management method according to a conventional technique does not examine duplication of a file in a real operation system and is stored and operates in an operation server, storage and system expansions are needed due to duplicated files. Accordingly, system installation cost is increased, and manpower and cost needed for operating the system are also increased.

When the distributed storage system is associated with systems for backup, Information Lifecycle Management (ILM), remote synchronization, mirror, archive, replication or the like, duplicated files are moved, and thus storage space and network resources of an individual system are wasted.

### DISCLOSURE OF INVENTION

### Technical Problem

Therefore, the present invention has been made in view of the above problems, and it is an object of the present invention to provide an apparatus and method for examining duplication of an active file and eliminating duplication of the file using a hash algorithm, bit level comparison and the like in a distributed storage system.

Another object of the present invention is to provide an apparatus and method for eliminating duplication of a file, in which unnecessary storage and system expansions required due to duplicated files are prevented by eliminating the duplicated files (data or contents) in the process of operating a system.

Still another object of the present invention is to provide an apparatus and method for eliminating duplication of a file, in which duplicated files are not transmitted when the distributed storage system is associated with systems for backup, Information Lifecycle Management (ILM), remote synchronization, mirror, archive, replication or the like, and thus unnecessary storage expansion and waste of network resources are prevented in an individual system.

Still another object of the present invention is to provide an apparatus and method which can support various types of hash algorithms when duplication of a file is examined and eliminated in a distributed storage system, examine and eliminate duplication of a file by the unit of file and/or chunk, and examine and eliminate duplication of a file for the whole system, for each volume or for each associated system.

Still another object of the present invention is to provide a distributed storage system efficiently using the apparatus and method for eliminating duplication of a file described above.

### Technical Solution

To accomplish the above objects, according to one aspect of the present invention, there is provided a file duplication examination apparatus of a distributed storage system, the apparatus including: a fingerprinting unit for calculating a hash value of each chunk for an active file and calculating a secondary hash value by adding the hash values calculated for respective chunks; a duplication examination unit for examining duplication of the file using the hash value of each chunk and the secondary hash value; and a duplicate file elimination unit for eliminating a duplicated file depending on a result of the examination.

According to one aspect of the present invention, there is provided a distributed storage system including: a plurality of storage servers for storing a file in a distributed manner; and a metadata server for managing metadata of the file, wherein the metadata server calculates a hash value of each chunk for an active file and calculating a secondary hash value by adding the hash values calculated for respective chunks, examines duplication of the file using the hash value of each chunk and the secondary hash value, and eliminates a duplicated file depending on a result of the examination.

According to one aspect of the present invention, there is provided a file duplication examination method of a distributed storage system, the method including the steps of: calculating a hash value of each chunk for an active file; calculating a secondary hash value by adding the hash values calculated for respective chunks; examining duplication of the file using the hash value of each chunk and the secondary hash value; and eliminating a duplicated file depending on a result of the examination.

### Advantageous Effects

According to the present invention, files can be managed efficiently by examining and eliminating duplication of active files using a hash algorithm, an algorithm of its own and the like in a distributed storage system.

According to the present invention, unnecessary storage and system expansions required due to duplicated files are prevented by eliminating duplicated files (data or contents) in the process of operating a system, and thus system installation cost, as well as manpower and cost needed for operating the system, is saved.

In addition according to the present invention, duplicated files (data or contents) are not transmitted by examining duplication of files in a real operation system when the distributed storage system is associated with systems for backup, Information Lifecycle Management (ILM), remote synchronization, mirror, archive, replication or the like, and thus waste of storage space and network resources of an individual systems can be prevented.

### BRIEF DESCRIPTION OF THE DRAWINGS

FIG. 1 is a view showing the configuration of a distributed storage system according to a conventional technique.

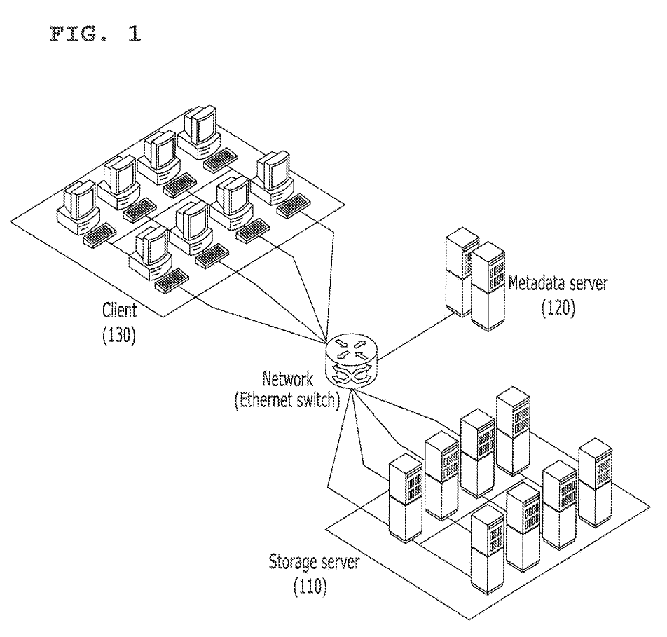

FIG. 2 is a view showing the configuration of a distributed storage system according to an embodiment of the present invention.

FIG. 3 is a view showing the configuration of a distributed storage system according to another embodiment of the present invention.

FIG. 4 is a view showing the detailed configuration of a file duplication elimination apparatus according to an embodiment of the present invention.

FIG. 5 is a view showing the detailed configuration of a file duplication elimination apparatus according to another embodiment of the present invention.

FIG. 6 is a flowchart illustrating a file duplication elimination method according to an embodiment of the present invention.

FIG. 7 is a flowchart illustrating a file duplication elimination method according to another embodiment of the present invention.

FIG. 8 is a view showing the task of eliminating duplication by the unit of file in a file duplication elimination apparatus (server) and/or the task of eliminating duplication by the unit of chunk among individual storage servers.

FIG. 9 is a view showing the task of eliminating duplication by the unit of chunk in an individual storage server.

### BEST MODE FOR CARRYING OUT THE INVENTION

The preferred embodiments of the present invention will be hereafter described in detail, with reference to the accompanying drawings. Furthermore, in the drawings illustrating the embodiments of the present invention, elements having like functions will be denoted by like reference numerals and details thereon will not be repeated.

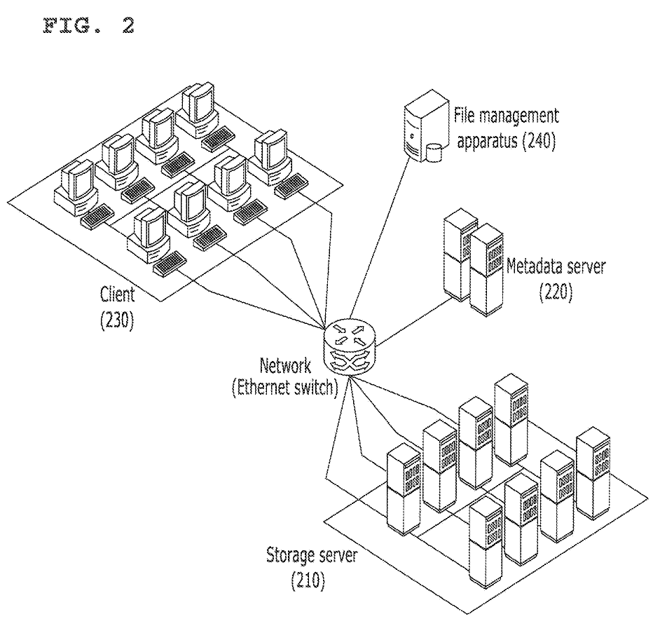

First, FIG. 2 is a view showing the configuration of a distributed storage system according to an embodiment of the present invention.

Referring to FIG. 2, a distributed storage system according to an embodiment of the present invention includes a plurality of storage servers 210 for duplicating and storing a file in a distributed manner, a metadata server 220 for creating and managing metadata of the file stored in the plurality of storage servers 210, and a file duplication elimination apparatus 240 for examining duplication of a currently operating active file and eliminating duplicated files. Here, the plurality of storage servers 210 may be implemented to be separated into operation servers and backup servers, and in this case, it is preferable that the operation server is implemented in a relatively high-speed storage server, and the backup server is implemented in a relatively low-speed high-capacity storage server. In addition, the file duplication elimination apparatus 240 examines duplication of an active file and eliminates duplicated files in the process of operating the system, and therefore, the file duplication elimination apparatus 240 improves overall system performance by preventing waste of storage and network resources and performing efficient file management and economic disk management.

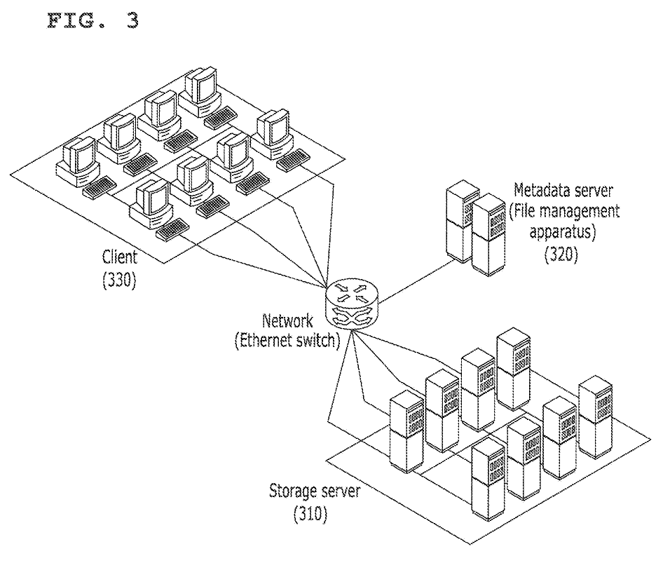

FIG. 3 is a view showing the configuration of a distributed storage system according to another embodiment of the present invention.

Referring to FIG. 3, a distributed storage system according to another embodiment of the present invention includes a plurality of storage servers 310 for duplicating and storing a file in a distributed manner, and a metadata server 320 for creating and managing metadata of the file stored in the plurality of storage servers 310. Particularly, since the metadata server 320 includes the functions of the file duplication elimination apparatus according to the present invention, it performs efficient file management and economic disk management by examining duplication of a currently operating active file and eliminating duplicated files.

Describing additionally, the file duplication elimination apparatus according to the present invention is configured as a separate apparatus or server in a distributed storage system (refer to FIG. 2) or configured as the metadata server itself or a part of the metadata server (refer to FIG. 3). The file duplication elimination apparatus examines duplication of a currently operating active file and eliminates duplicated files, and thus improves system performance by efficiently utilizing limited storage media.

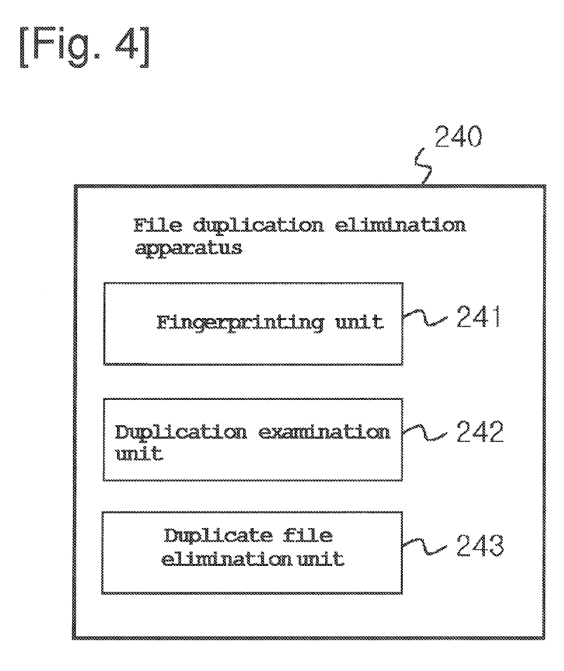

In relation to this, FIG. 4 is a view showing the detailed configuration of a file duplication elimination apparatus according to an embodiment of the present invention. As shown in the figure, a file duplication elimination apparatus 240 according to an embodiment of the present invention includes a fingerprinting unit 241, a duplication examination unit 242 and a duplicate file elimination unit 243, and particularly, the file duplication elimination apparatus 240 can be advantageously applied to the distributed storage system shown in FIG. 2.

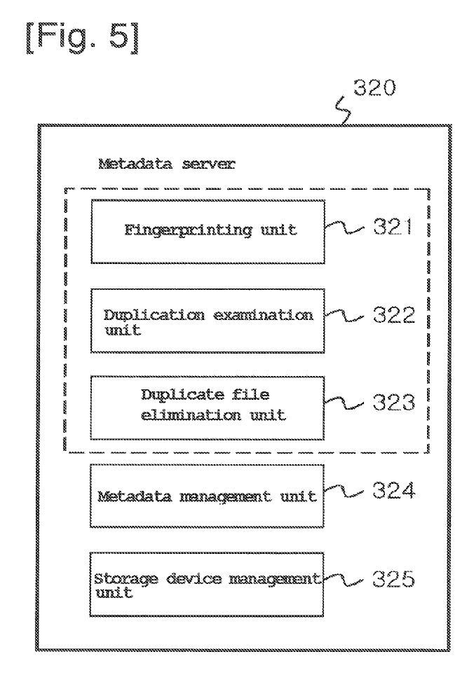

In addition, FIG. 5 is a view showing the detailed configuration of a file management apparatus 320 according to another embodiment of the present invention. As shown in the figure, a file management apparatus 320 according to another embodiment of the present invention includes a fingerprinting unit 321, a duplication examination unit 322, a duplicate file elimination unit 323, a metadata management unit 324 and a storage device management unit 325, and particularly, the file duplication elimination apparatus 320 can be advantageously applied to the distributed storage system shown in FIG. 3.

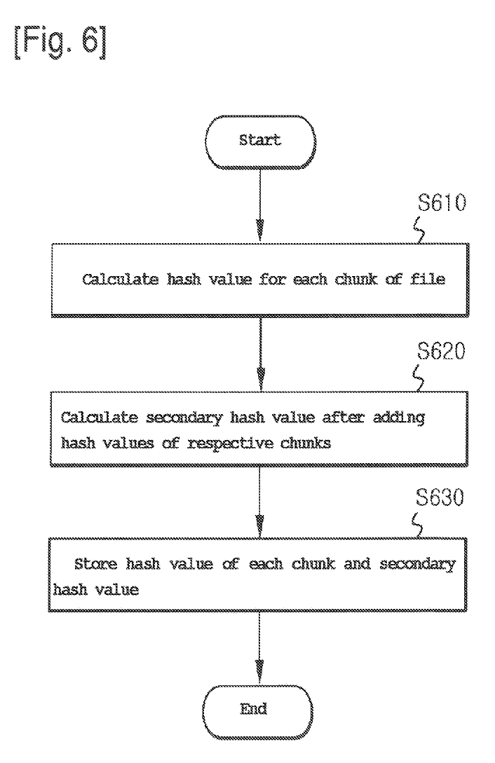

Meanwhile, FIG. 6 is a flowchart illustrating a file duplication elimination method according to an embodiment of the present invention. Specifically, fingerprinting is performed by calculating a hash value for an operating file by the chunk and then calculating a secondary hash value by adding hash values of respective chunks.

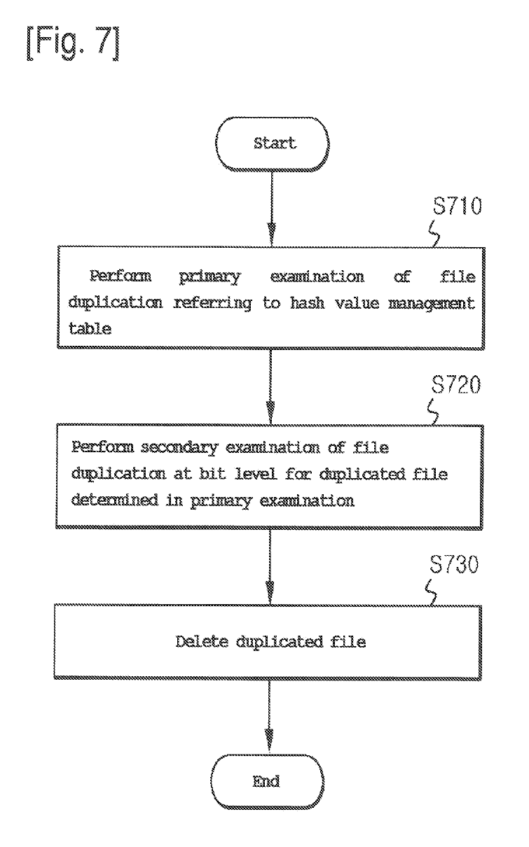

FIG. 7 is a flowchart illustrating a file duplication elimination method according to another embodiment of the present invention. Specifically, duplication of an active file is examined in the process of creating, deleting and copying a file, and duplicated files are eliminated.

Hereinafter, an apparatus and method for eliminating duplication of a file in a distributed storage system according to the present invention will be described with reference to FIGS. 2 to 9. For reference, practically the same or similar configurations and functions will be described equally without discrimination although embodiments of the present invention are somewhat different.

First, referring to FIGS. 4 and 5, the fingerprinting unit 241 and 321 of the file duplication elimination apparatus according to the present invention performs fingerprinting by calculating a hash value by the unit of file and/or chunk for a file (data or contents) flowing into the distributed storage system.

For example, the fingerprinting unit 241 and 321 calculates a hash value by the unit of chunk for a currently operating active file using a certain hash algorithm (MD2, MD4, MD5, SHA, SHA-1, RIPEMD160, or DSS-1) (refer to S610 of FIG. 6). Then, the fingerprinting unit 241 and 321 calculates a secondary hash value using a certain hash algorithm after adding all hash values calculated by the unit of chunk for corresponding files (refer to S620 of FIG. 6). Here, the secondary hash value is a hash value of a file unit, and the hash algorithm used in step S610 and the hash algorithm used in step S620 may be the same or different. The fingerprinting unit 241 and 321 stores the hash value of each chunk and the secondary hash value calculated like this in the metadata server, the storage server (operation server), a database and the like (refer to S630 of FIG. 6).

In relation to step S630, according to a preferred embodiment of the present invention, the hash value of a chunk unit is included in the chunk header and the metadata payload, and the hash value of a file unit (secondary hash value) is included in the metadata header. Specifically, the file duplication elimination apparatus according to the present invention calculates a hash value of a chunk unit and a hash value of a file unit and transmits the calculated hash values to the metadata server, and the metadata server creates or updates metadata of a corresponding file by including the file unit hash value in the metadata header and the chunk unit hash value in the metadata payload and.

In addition, according to a preferred embodiment of the present invention, the chunk unit hash value and the file unit hash value are stored in memory and the database in the form of a hash value management table. Specifically, a chunk unit hash value management table is stored in the memory of an individual storage server (individual operation server) storing corresponding chunks, and a file unit hash value management table is stored in the memory of the file duplication elimination apparatus (file duplication elimination server). In addition, the chunk unit hash value management table and/or the file unit hash value management table are stored in a database, and here, the database may be provided within the file duplication elimination apparatus (file duplication elimination server) according to the present invention or provided in the form of a separate database server. Since the present invention is implemented in this manner, a hash value of a file and/or a chunk does not need to be detected every time, and particularly, the hash values do not need to be detected again in a situation where restoration is needed, such as restart of the file duplication elimination apparatus (file duplication elimination server), restart of an individual storage server (individual operation server), or reinstallation of a database.

Meanwhile, the duplication examination unit 242 and 322 of the file duplication elimination apparatus according to the present invention examines duplication of a currently operating file with reference to the hash management table described above.

For example, the duplication examination unit 242 and 322 performs a primary duplication examination on an operating file by reviewing duplication, referring to the file unit hash value management table and/or the chunk unit hash value management table based on file unit hash value and/or the chunk unit hash value (refer to S710 of FIG. 7). In this case, the duplication examination unit 242 and 322 refers to the memory first. If a corresponding table is in the memory, duplication is promptly examined, and if a corresponding table is not in the memory, duplication is examined referring to the database. Then, if it is determined that the file and/or the chunk is identical to the operating file as a result of the primary duplication examination, the duplication examination unit 242 and 322 may perform a secondary duplication examination which compares the file and/or the chunk at the bit level (refer to S720 of FIG. 7). Here, the chunk unit comparison, the file unit comparison or the bit level comparison may be set by the system manager (operator), and the size of the chunk may also be set (modified) by the system manager.

If the file is determined as being duplicated as a result of the examination performed by the duplication examination unit 242 and 322, the duplicate file elimination unit 243 and 323 of the file management apparatus according to the present invention eliminates relevant files (refer to S730 of FIG. 7). Here, the files may also be eliminated by the unit of file and/or chunk.

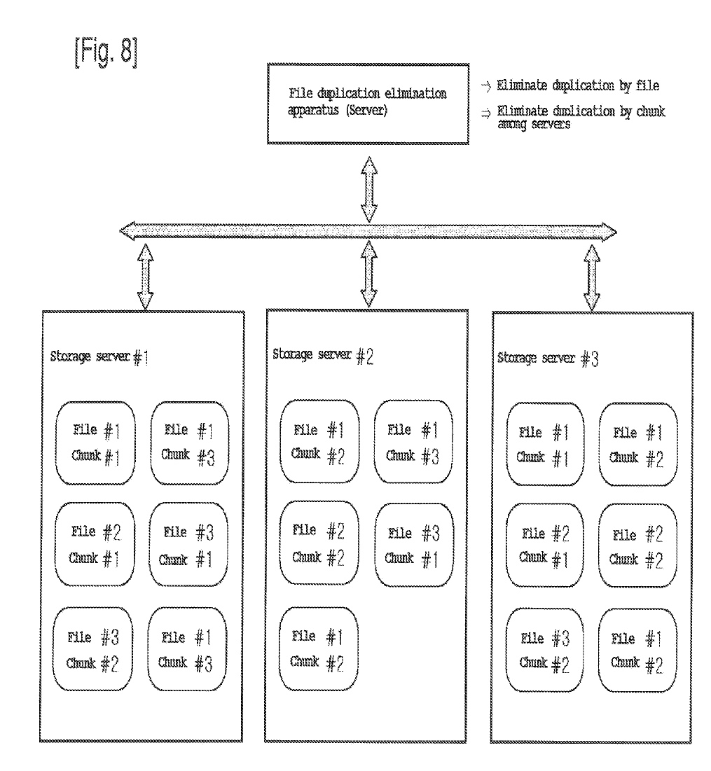

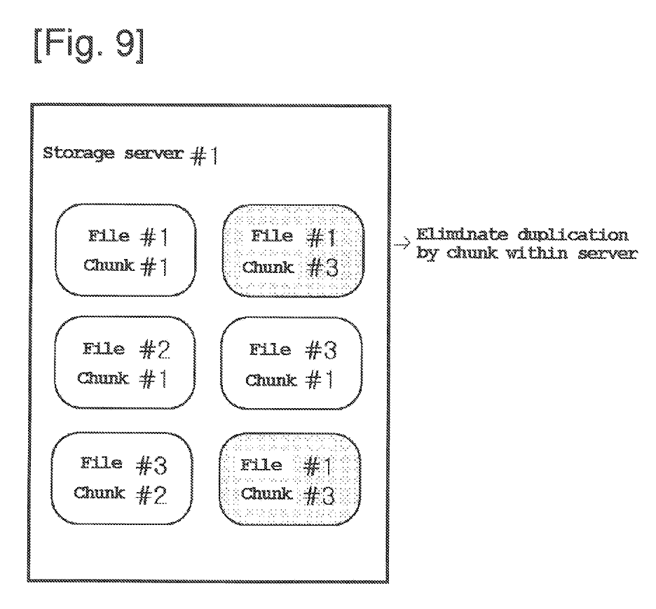

In relation to duplication examination and elimination of a file, according to a preferred embodiment of the present invention, duplication examination and elimination by the unit of file may be performed by the file duplication elimination apparatus (file duplication elimination server) (refer to FIG. 8), and duplication examination and elimination by the unit of chunk may be performed by an individual storage server (individual operation server) (refer to FIG. 9). That is, according to the present invention, the individual storage server storing chunks eliminates by itself the chunks duplicated in the individual storage server by performing duplication examination and elimination by the chunk. Therefore, loads of the file duplication elimination apparatus (server) according to the present invention are reduced, and thus overall system performance can be improved. Here, it is apparent that the file duplication elimination apparatus (file duplication elimination server) preferably takes charge of eliminating duplication of a chunk among different storage servers.

Meanwhile, elimination of a duplicated file may be elimination of a file or a chunk itself, or elimination of the duplicated file can be performed by creating, modifying and deleting a chunk unit pointer for the file. For example, in the case of a file creation process, if a file is duplicated as a result of performing duplication examination on the file, a chunk unit pointer of the file is modified, and the file is deleted. In the case of file deletion process, only the chunk unit pointer of the file is deleted, and in the case of file copy process, only a chunk unit pointer of the file is created.

Finally, referring to FIG. 5, the metadata management unit 324 and the storage device management unit 325 are constitutional components that can be further included if the file management apparatus according to the present invention is implemented in a metadata server.

Describing in short, the metadata management unit 324 creates and manages metadata of the files stored in a plurality of storage servers (operation servers and backup servers) in a distributed manner, and the storage device management unit 325 manages information on performance and capacity of the plurality of storage servers. Accordingly, the file duplication elimination apparatus according to the present invention may further efficiently manage the files in association with the metadata management unit 324 and/or the storage device management unit 325.

Meanwhile, the method of eliminating duplication of a file in a distributed storage system according to the present invention may be embodied through a computer readable recording medium containing program commands for performing operations implemented in a variety of computers. The computer readable medium may include program commands, data files, data structures and the like in a single or combined form. The recording medium may be a medium that is specially designed and configured for the present invention or medium that is publicized and available for those skilled in the computer software art. Examples of the computer readable medium include magnetic media such as a hard disk, a floppy disk and a magnetic tape, optical media such as a CD-ROM and a DVD, magneto-optical media such as a floptical disk, and hardware devices specially configured to store and execute the program commands, such as ROM, RAM and flash memory. Examples of the program commands include high-level language codes that can be executed by a computer using an interpreter or the like, as well as machine codes such as those generated by a compiler.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A file duplication elimination apparatus for eliminating duplication of a file in a distributed storage system, the apparatus comprising:
a fingerprinting unit for calculating a hash value of each chunk for an active file and calculating a secondary hash value by adding the hash values calculated for respective chunks;
a duplication examination unit for examining duplication of the file using the hash value of each chunk and the secondary hash value; and
a duplicate file elimination unit for eliminating a duplicated file depending on a result of the examination.

2. The apparatus according to claim 1, wherein the duplication examination unit examines duplication of the file by performing at least one of chunk unit comparison, file unit comparison and bit level comparison using the hash value of each chunk and the secondary hash value.

3. The apparatus according to claim 1, wherein the hash value of each chunk is stored in a chunk header and a metadata payload, and the secondary hash value is stored in a metadata header.

4. The apparatus according to claim 1, wherein the hash value of each chunk and the secondary hash value are stored in either memory or a database respectively in a form of a chunk unit hash value management table and in a form a file unit hash value management table.

5. The apparatus according to claim 4, wherein the duplication examination unit examines duplication of the file by referring to the memory firstly and referring to the database secondly.

6. The apparatus according to claim 1, wherein the duplicate file elimination unit eliminates the duplicated file by a unit of file or a chunk.

7. The apparatus according to claim 6, wherein the duplicate file elimination unit eliminates the duplicated file by performing at least one of creation, modification and deletion of a chunk unit pointer.

8. The apparatus according to claim 1, further comprising a metadata management unit for managing metadata of the file.

9. A distributed storage system comprising:
a plurality of storage servers for storing a file in a distributed manner; and
a metadata server for managing metadata of the file, wherein
the metadata server calculates a hash value of each chunk for an active file and calculating a secondary hash value by adding the hash values calculated for respective chunks, examines duplication of the file using the hash value of each chunk and the secondary hash value, and eliminates a duplicated file depending on a result of the examination.

10. The system according to claim 9, wherein the metadata server stores the hash value of each chunk in a metadata payload and stores the secondary hash value in a metadata header.

11. The system according to claim 9, wherein the metadata server examines duplication of the file by performing at least one of chunk unit comparison, file unit comparison and bit level comparison using the hash value of each chunk and the secondary hash value.

12. The system according to claim 9, wherein the metadata server performs duplication examination and elimination by a unit of file, and the storage server individually performs duplication examination and elimination by a unit of chunk.

13. The system according to claim 9, further comprising a database for storing the hash value of each chunk in a form of a chunk unit hash value management table and storing the secondary hash value in a form of a file unit hash value management table.

14. A file duplication elimination method for eliminating duplication of a file in a distributed storage system, the method comprising the steps of:
calculating a hash value of each chunk for an active file;
calculating a secondary hash value by adding the hash values calculated for respective chunks;
examining duplication of the file using the hash value of each chunk and the secondary hash value; and
eliminating a duplicated file depending on a result of the examination.

15. The method according to claim 14, wherein the step of examining duplication of the file includes the steps of:
performing a primary duplication examination by searching a hash value management table based on the hash value of each chunk and the secondary hash value; and
performing a secondary duplication examination by performing bit level comparison if the file duplicated as a result of the primary duplication examination.

16. The method according to claim 14, wherein the step of eliminating a duplicated file performs at least one of the steps of:
creating a chunk unit pointer;
modifying the chunk unit pointer; and
deleting the chunk unit pointer.

17. The method according to claim 14, wherein the hash value of each chunk is stored in a chunk header and a metadata payload, and the secondary hash value is stored in a metadata header.

18. A computer readable recording medium for recording a program which performs the file duplication eliminating method according to claim 14.
